(19) United States
(12) Patent Application Publication
(10) Pub. No.: US 2012/0186156 A1
(43) Pub. Date: Jul. 26, 2012

(54) MIXER OF COMBUSTIBLE GAS AND COMBUSTION SUPPORTING GAS

(75) Inventors: Ryo Hatano, Ibaraki-shi (JP); Naoki Shimada, Niihama-shi (JP); Eisaburo Miyata, Ichikawa-shi (JP)

(73) Assignee: SUMITOMO CHEMICAL COMPANY, LIMITED, Chuo-ku, Tokyo (JP)

(21) Appl. No.: 13/498,266

(22) PCT Filed: Sep. 27, 2010
(86) PCT No.: PCT/JP2010/067304

§ 371 Date: Mar. 26, 2012

(30) Foreign Application Priority Data
Sep. 30, 2009 (JP) 2009-226846

(51) Int. Cl. B01F 3/02

(52) U.S. Cl. 48/180.1

(57) ABSTRACT

A mixer (10) for mixing a combustible gas and a combustion supporting gas comprises a tubular mixing section (1) which extends between one end (1a) having a combustible gas supply port (2) and the other end (1b) having a mixed gas discharge port (3); and a combustion supporting gas supply tube (4) which is inserted into the tubular mixing section (1) between the one end (1a) and the other end (1b) of the tubular mixing section (1) and has a combustion supporting gas supply port (5) at its tip (4a) to open towards the other end (1b) of the tubular mixing section (1). A juxta-tip part (4b) of the combustion supporting gas supply tube (4) has an outer shape tapered towards the combustion supporting gas supply port (5) at the tip (4a).

### TECHNICAL FIELD

The present invention relates to a mixer of a combustible gas and a combustion supporting gas, and a process for producing a mixed gas.

### BACKGROUND ART

A mixed gas of a combustible gas and a combustion supporting gas is used for various reaction processes. For example, it is known that a mixed gas obtained by mixing hydrocarbon gas, e.g. methane, as the combustible gas with the combustion supporting gas such as oxygen is used for a disproportionation reaction for producing carbon monoxide and hydrogen. It is also known that a mixed gas obtained by mixing the combustible gas including hydrogen with the combustion supporting gas including oxygen is used for an oxidation reaction for producing hydrogen peroxide and further an epoxidation reaction for epoxidizing an olefin with the hydrogen peroxide.

As a mixing apparatus of a combustible gas and a combustion supporting gas, for example, there is known a mixing apparatus having a mixing vessel to which the combustible gas and the combustion supporting gas are supplied, wherein the mixing vessel is filled with packing to form many narrow gas passages and increase a flow velocity of the gas flowing through the mixing vessel (See JP 2009-29680 A).

### SUMMARY OF INVENTION

### Technical Problem

When a combustible gas and a combustion supporting gas are mixed by the conventional mixing apparatus, there is a fear that a combustion reaction may occur during the mixing and there is a concern of propagation of the combustion reaction. In order to attain safer mixing, a mixing apparatus is required which has no fear of propagation of a combustion reaction even if the combustion reaction occurs.

### Solution to Problem

In these circumstances, as a result of diligent consideration by the inventors on a mixing apparatus of a combustible gas (or a flammable gas) and a combustion supporting gas (or a gas supporting burning of the flammable gas), the present invention has been accomplished as follows.

In one aspect of the present invention, there is provided a mixer for mixing a combustible gas and a combustion supporting gas, which comprises:

a tubular mixing section which extends between one end having a combustible gas supply port and the other end having a mixed gas discharge port; and

a combustion supporting gas supply tube which is inserted into the tubular mixing section between the one end and the other end of the tubular mixing section and has a combustion supporting gas supply port at its tip to open towards the other end of the tubular mixing section;

wherein a juxta-tip part of the combustion supporting gas supply tube has an outer shape tapered towards the combustion supporting gas supply port at the tip.

In the above mixer, a longitudinal direction of the tubular mixing section may be generally perpendicular to an aperture plane of the combustion supporting gas supply port.

In the above mixer, additionally or alternatively, a central axis of the combustion supporting gas supply tube at the juxta-tip part may be generally parallel to a longitudinal direction of the tubular mixing section.

In another aspect of the present invention, there is provided a process for producing a mixed gas, which comprises:

using the mixer according to any of claims 1 to 3;

supplying a combustible gas into the tubular mixing section from the combustible gas supply port located at the one end of the tubular mixing section;

supplying a combustion supporting gas into the tubular mixing section from the combustion supporting gas supply port;

mixing the combustible gas and the combustion supporting gas between the combustion supporting gas supply port and the other end of the tubular mixing section;

discharging a mixed gas obtained thereby from the mixed gas discharge port located at the other end of the tubular mixing section.

In one embodiment of the above process for producing the mixed gas, the process further comprises:

controlling the supply of the combustible gas into the tubular mixing section so that a flow velocity of the combustible gas at the combustion supporting gas supply port is not less than a combustion velocity of the mixed gas of the combustible gas and the combustion supporting gas.

Regarding the process for producing the mixed gas of the present invention, the combustible gas may comprise hydrogen, and the combustion supporting gas may comprise oxygen. The combustible gas may further comprise propylene, and/or may further comprise an inert component.

### Advantageous Effects of Invention

According to the present invention, there is provided a safer mixer which can make mixing rapidly within a concentration range to prevent propagation of a combustion reaction although a combustible gas and a combustion supporting gas are mixed together.

### BRIEF DESCRIPTION OF DRAWINGS

FIG. 1 shows a mixer in one embodiment of the present invention; FIG. 1 (a) schematically shows a cross sectional view of the mixer; FIG. 1 (b) schematically shows an enlarged cross sectional view of a region X in FIG. 1 (a); and FIG. 1 (c) shows a view corresponding to FIG. 1 (b) and indicates a central axis C of a combustion supporting gas supply tube at a juxta-tip part (in FIGS. 1 (b) and (c), the combustion supporting gas supply tube is shown by omitting its insertion part through a tubular mixing section).

FIG. 2 shows a graph of an equilateral-triangular coordinate of a combustible gas of 5 parts by weight of propylene and 1.7 parts by weight of hydrogen (Propylene+H₂), a combustion supporting gas (Oxygen, O₂), and an inert gas (Nitrogen, N₂).

FIG. 3 schematically shows a partially enlarged cross sectional view of a mixer in a comparative example.

FIG. 4 shows a mixer in another embodiment of the present invention; FIG. 4 (a) schematically shows a cross sectional view of the mixer; and FIG. 4 (b) schematically shows an enlarged cross sectional view of a region X in FIG. 4 (a) (in FIG. 4 (b), a combustion supporting gas supply tube is shown by omitting its insertion part through a tubular mixing section).

Following reference numbers or signs denote the following elements:

1, 1′, 61 . . . tubular mixing section

1a . . . one end

1b . . . the other end

1c . . . tapered part

2 . . . combustible gas supply port

3 . . . mixed gas discharge port

4, 64 . . . combustion supporting gas supply tube

4a, 64a . . . tip

4b . . . juxta-tip part

5, 65 . . . combustion supporting gas supply port

10, 10′ . . . mixer

D1, D2 . . . inner diameter

X . . . Propylene+H₂ (combustible component of combustible gas) 100% by volume

Y . . . O₂ (combustion supporting gas) 100% by volume

Z . . . N₂ (inert component of combustible gas) 100% by volume

A . . . stoichiometric composition

B . . . limiting oxygen concentration

Line AB . . . stoichiometric composition line

C . . . lower explosion limit (O₂)

D . . . upper explosion limit (O₂)

Line BC, Line BD . . . explosion limit

E . . . composition of combustible gas to be supplied

Line EY . . . operating line

F, G . . . limiting concentration

H . . . intersection of stoichiometric composition line and operating line

### DESCRIPTION OF EMBODIMENTS

### Embodiment 1

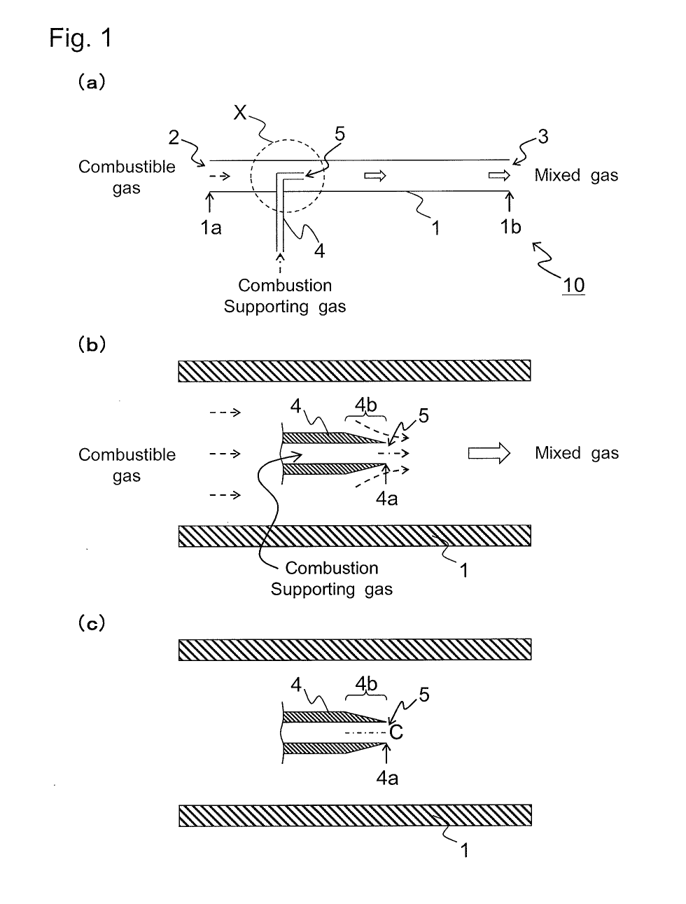

A mixer and a process for producing a mixed gas in one embodiment of the present invention will be described with reference to FIG. 1.

Referring to FIG. 1 (a), a mixer 10 in this embodiment is provided with a tubular mixing section 1 extending between one end 1a and the other end 1b; and a combustion supporting gas supply tube 4 inserted into the tubular mixing section 1 between the one end 1a and the other end 1b of the tubular mixing section 1.

The tubular mixing section 1 is a member for mixing a combustible gas and a combustion supporting gas therein, and has a combustible gas supply port 2 at the one end 1a and a mixed gas discharge port 3 at the other end 1b. The tubular mixing section 1 may be of any shape as long as it has a continuous body between these opposing ends 1a and 1b. The tubular mixing section 1 may have any cross-sectional shape and any cross-sectional area, but the tubular mixing section 1 shown in the drawings as the embodiment has a generally circular cross-section.

The combustion supporting gas supply tube 4 is inserted into the tubular mixing section 1 between the one end 1a and the other end 1b of the tubular mixing section 1 and has a combustion supporting gas supply port 5 at its tip. The combustion supporting gas supply port 5 is open towards the other end 1b (downstream side, i.e. right side in FIGS. 1 (a) to (c)) of the tubular mixing section 1. As shown in FIG. 1 (b), a juxta-tip part (a part in the vicinity of the tip) 4b of the combustion supporting gas supply tube 4 has an outer shape (or profile) tapered towards the combustion supporting gas supply port 5 at the tip 4a. It is preferable that a longitudinal direction (a direction through the one end 1a and the other end 1b) of the tubular mixing section 1 is generally perpendicular to an aperture plane of the combustion supporting gas supply port 5 as shown in FIG. 1 (b). For example, the combustion supporting gas supply tube 4 is inserted into the tubular mixing section 1 between the one end 1a and the other end 1b of the tubular mixing section 1 as shown in FIG. 1 (a), and may be bent as shown in FIG. 1 (c) so that a central axis C (shown by a dashed-dotted line in FIG. 1 (c)) of the combustion supporting gas supply tube 4 at the juxta-tip part 4b is generally parallel to the longitudinal direction of the tubular mixing section 1, preferably coaxially with the tubular mixing section 1. The combustion supporting gas supply tube 4 may have any suitable cross-sectional shape and cross-sectional area, but the combustion supporting gas supply tube 4 shown in the drawings as the embodiment has a generally circular cross-section. The combustion supporting gas supply tube 4 can be equipped with, in general, a control valve (not shown in the drawings) for controlling a flow rate of the combustion supporting gas flowing therethrough, but this is not necessary for this embodiment.

Using the mixing apparatus 10, the combustible gas and the combustion supporting gas are mixed together. The combustible gas is any gas including a component which is able to combust by a reaction with oxygen (hereinafter referred to as a “combustible component”). For example, the combustible component is hydrogen, hydrocarbon compounds including olefins, and a mixture of at least two of them, and the like. In addition to the combustible component, the combustible gas may further include an inert component such as nitrogen, moisture and so on. The combustion supporting gas is any gas including oxygen. For example, the combustion supporting gas is oxygen gas, air, and the like.

With the use of a combustible gas transport device (not shown in the drawings) such as a centrifugal compressor, an axial flow compressor, a volume compressor, a fan, a blower, and so on, the combustible gas is supplied into the tubular mixing section 1 from the combustible gas supply port 2 located at the one end 1a. Also, the combustion supporting gas is supplied into the tubular mixing section 1 from the combustion supporting gas supply port 5 through the combustion supporting gas supply tube 4. The combustible gas, which is supplied in this way, passes by a periphery of the juxta-tip part 4b of the combustion supporting gas supply tube 4, and then flows within the tubular mixing section 1 together with the combustion supporting gas, which is supplied from the combustion supporting gas supply port 5. Finally, a mixed gas of the combustible gas and the combustion supporting gas is obtained from the mixed gas discharge port 3 located at the other end 1b of the tubular mixing section 1. In the drawings, the combustible gas is shown by arrowed and dotted lines, the combustion supporting gas is shown by an arrowed and dashed-dotted line; and the mixed gas is shown by an arrowed white line.

In the meantime, as shown in FIG. 3, when a combustion supporting gas supply tube 64 is a general tube which is not tapered towards a combustion supporting gas supply port 65 at its tip 64a, a vortex flow (schematically shown by spiral patterns in FIG. 3) is formed around the combustion supporting gas supply port 65 (a downstream side of the edge of the tip 64a) on mixing a combustible gas with a combustion supporting gas. This vortex flow tends to suppress rapid mixing of the combustible gas and the combustion supporting gas.

On the contrary, according to the present embodiment, since the juxta-tip part 4b of the combustion supporting gas supply tube 4 is tapered towards the combustion supporting gas supply port 5 at the tip 4a, it is possible to effectively prevent a vortex flow from being formed at the combustion supporting gas supply port 5, which would have formed on mixing the combustible gas and the combustion supporting gas (see FIG. 1 (b)). As a result, although the combustible gas and the combustion supporting gas are mixed together, the mixing can be rapidly made within a concentration range at which propagation of a combustion reaction can be prevented, and thereby occurrence and propagation of the combustion reaction is hard to be caused, and higher safety is attained.

Further, preferably in this embodiment, the longitudinal direction of the tubular mixing section 1 is generally perpendicular to the aperture plane of the combustion supporting gas supply port 5, and therefore disturbance to the flow of the combustible gas by the combustion supporting gas supply tube tends to be reduced. When a combustion supporting gas supply tube is a general straight tube, as shown in FIG. 3, a vortex flow tends to be easily formed at a downstream side of the combustible gas in the vicinity of the combustion supporting gas supply tube forming the combustion supporting gas supply port 65. On the contrary, in the mixer of the present invention, since the longitudinal direction of the tubular mixing section 1 is generally perpendicular to the aperture plane of the combustion supporting gas supply port 5, the flow of the combustible gas and the flow of the combustion supporting gas become generally parallel to each other, as a result the formation of a vortex flow described above tends to be reduced. Further, preferably in this embodiment, since the central axis C of the combustion supporting gas supply tube 4 at the juxta-tip part 4b is generally parallel to the longitudinal direction of the tubular mixing section 1, and therefore the flow of the combustible gas and the flow of the combustion supporting gas become generally parallel further more to each other, as a result the formation of a vortex flow described above tends to be reduced.

In addition, in this embodiment it is preferable to control (or adjust) the supply of the combustible gas into the tubular mixing section so that a flow velocity of the combustible gas at the combustion supporting gas supply port 5 is not less than a combustion velocity of the mixed gas of the combustible gas and the combustion supporting gas. By controlling in this way, even if a combustion reaction occurs, the combustible gas flows at the flow velocity not less than the combustion velocity, and therefore it is possible to effectively prevent the combustion reaction from being propagated.

Due to the “flow velocity of the combustible gas at the combustion supporting gas supply port” being not less than the combustion velocity of the mixed gas of the combustible gas and the combustion supporting gas, occurrence and propagation of the combustion reaction tends to be suppressed even in the vicinity of the combustion supporting gas supply port 5 where a concentration of the combustion supporting gas is considered to be relatively high. The smaller concentration of the combustion supporting gas is more preferred since ignition tends to be more difficult. The flow velocity of the combustible gas at the combustion supporting gas supply port 5 can be calculated based on the size and shape of the used tubular mixing section 1, the position of the combustion supporting gas supply port 5 in the tubular mixing section 1 and so on, and can be controlled by changing the supply rate (or amount) of the combustible gas from the combustible gas supply port 2.

The combustion velocity of the mixed gas of the combustible gas and the combustion supporting gas is calculated based on a composition of the mixed gas. The combustion velocity of the mixed gas having a certain composition is measurable according to a known spherical bomb technique which is described in “The Burning Velocity Measurement by Means of the Spherical Bomb Technique”, Tadao TKENO and Toshio IIJIMA, Bulletin of the Institute of Space and Aeronautical Science, University of Tokyo, 17(1_B), pp 261-272, 1980. Generally, a mixed gas prepared to have a certain composition is charged into a spherical bomb and ignited; a change in a pressure over time is measured; a combustion (or burning) velocity is calculated from results of the measurement.

The composition of the mixed gas of the combustible gas and the combustion supporting gas at the other end 1b of the tubular mixing section 1 is considered as being equal to a composition resulted by combining the combustible gas and the combustion supporting gas which are supplied. The composition of the gas in the tubular mixing section 1 at an upstream side (left side in FIGS. 1 (a) to (c)) from the combustion supporting gas supply port 5 is generally equal to the composition of the combustible gas which is supplied. The composition of the gas at a downstream side from the combustion supporting gas supply port 5 may be varied depending on flow conditions (or mixing conditions) from the point of view of microscopic scale.

When the combustible gas does not include an inert component, as the “combustion velocity of the mixed gas of the combustible gas and the combustion supporting gas”, a combustion velocity having a “stoichiometric” composition can be applied. The “stoichiometric composition” means herein a composition with respect to two components of the combustible component in the combustible gas and oxygen in the combustion supporting gas, in which oxygen exists at a theoretical amount necessary for combusting the combustible component. As the combustion supporting gas is mixed with the combustible gas gradually, the gas composition during the mixing moves from one corresponding to the composition of the combustible component of the supplied combustible gas, towards another corresponding to the oxygen content in the supplied combustion supporting gas. Then, it is contemplated that the maximum combustion velocity is attained when the gas composition reaches the stoichiometric composition because the oxygen content is just in proportion which is necessary for combusting the combustible component. Therefore, when the “flow velocity of the combustible gas at the combustion supporting gas supply port” is not less than a combustion velocity at the stoichiometric composition, propagation of the combustion reaction is supposed to be prevented sufficiently.

When the combustible gas includes an inert component, a combustion velocity having a certain composition can be applied. In a graph of an equilateral-triangular coordinate of three components (vol %) of a combustible component of the combustible gas, oxygen of the combustion supporting gas, and the inert component of the combustible gas, the certain composition is at an intersection of a stoichiometric composition line, on which the combustible component and oxygen forms a stoichiometric composition, and an “operating line”. The “operating line” means herein a line between a point indicating the composition of the combustible component and the inert component in the supplied combustible gas and a point indicating the oxygen content in the supplied combustion supporting gas. As the combustion supporting gas is mixed with the combustible gas gradually, the gas composition moves from the point indicating the composition of the combustible component and the inert component in the supplied combustible gas, towards the point indicating the oxygen content in the supplied combustion supporting gas, while tracing the operating line. Then, it is contemplated that the maximum combustion velocity is attained when the gas composition reaches the stoichiometric composition. Therefore, when the “flow velocity of the combustible gas at the combustion supporting gas supply port” is not less than a combustion velocity at this stoichiometric composition, propagation of the combustion reaction is supposed to be prevented sufficiently.

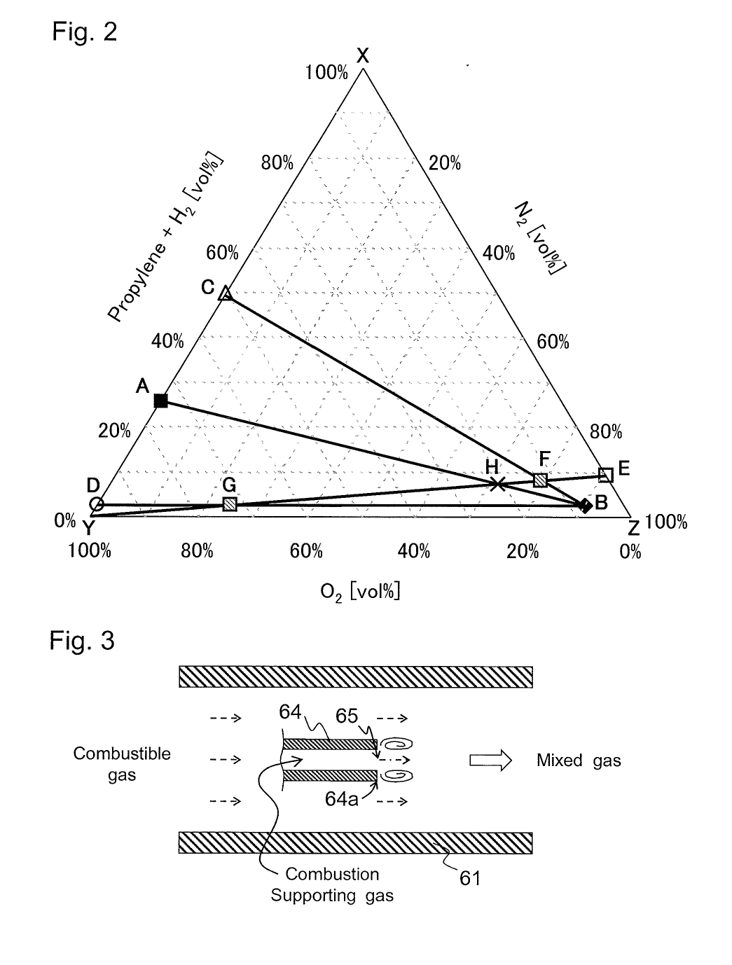

Hereinafter, the composition of the mixed gas for determining the “combustion velocity of the mixed gas of the combustible gas and the combustion supporting gas” is described more concretely with reference to FIG. 2.

FIG. 2 shows a graph of an equilateral-triangular coordinate of a combustible gas of 5 parts by weight of propylene and 1.7 parts by weight of hydrogen (Propylene+H₂), a combustion supporting gas (Oxygen, O₂), and an inert gas (Nitrogen, N₂). At a point X, Propylene+H₂=100% by volume; at a point Y, O₂=100% by volume; and at a point Z, N₂=100% by volume.

When a mixed gas of 5 parts by weight of propylene and 1.7 parts by weight of hydrogen is used as a combustible component of the combustible gas, a stoichiometric composition of the combustible component and oxygen (no nitrogen) is at a point A (Propylene+H₂=22.2% by volume; O₂=77.8% by volume) in FIG. 2. By adding nitrogen as an inert component to such a mixed gas gradually, the composition moves from the point A towards a point Z tracing a line AZ while maintaining the stoichiometric composition of the combustible component and oxygen. As a ratio of nitrogen comes to be high enough, explosion will not occur. A concentration of oxygen at this limit is referred to as a limiting oxygen concentration and indicated by a point B (Propylene+H₂=2.3% by volume; O₂=8.0% by volume) in FIG. 2. A line AB is a stoichiometric composition line. On the other hand, under the condition of no nitrogen, explosion will not occur when the concentration of oxygen is too low or too high. Concentrations of oxygen at these limits are referred to as a lower explosion limit (O₂) and an upper explosion limit (O₂), and indicated by a point C (Propylene+H₂=49.5% by volume; O₂=50.5% by volume) and a point D (Propylene+H₂=2.3% by volume; O₂=97.7% by volume), respectively. A line BC and a line BD are borders of explosion, and a region enclosed by the points B, C and D is a range of explosion.

When the combustible gas is composed of the combustible component in the form of the mixed gas of 5 parts by weight of propylene and 1.7 parts by weight of hydrogen and does not include an inert component, the stoichiometric composition of the combustible component and oxygen is at the point A in FIG. 2. An oxygen gas (O₂=100% by volume) is used as the combustion supporting gas and mixed with the above combustible gas gradually, the gas composition during the mixing moves from a point X towards a point Y tracing a line XY (N₂=0% by volume). It is contemplated that the maximum combustion velocity is attained when the gas composition reaches the stoichiometric composition of the point A. Therefore, the combustion velocity of the mixed gas having the composition of the point A is applied as the “combustion velocity of the mixed gas of the combustible gas and the combustion supporting gas.”

When the combustible gas is composed of the combustible component in the form of the mixed gas of 5 parts by weight of propylene and 1.7 parts by weight of hydrogen and an inert component of a nitrogen gas, a composition of the supplied combustible gas is assumed to be at a point E (Propylene+H₂=6.9% by volume; O₂=1.7% by volume; N₂=91.4% by volume), for descriptive purpose. An oxygen gas (O₂=100% by volume) is used as the combustion supporting gas and mixed with the above combustible gas gradually, the gas composition during the mixing moves from the point E towards the point Y tracing a line EY. It is contemplated that the maximum combustion velocity is attained when the gas composition reaches the stoichiometric composition of a point H. The point H is an intersection of the line EY as an operating line and the line AB as the stoichiometric composition line. Points F and G are intersections of the line EY as the operating line and the lines BC and BD respectively, and the points F and G mean limiting concentrations (upper and lower limits of a fuel concentration when a gas having the composition of the point E is mixed with a gas having the composition of the point Y (O₂=100% by volume)). Therefore, the combustion velocity of the mixed gas having the composition of the point H is applied as the “combustion velocity of the mixed gas of the combustible gas and the combustion supporting gas”.

When other components are used for the combustible gas and the combustion supporting gas, the “combustion velocity of the mixed gas of the combustible gas and the combustion supporting gas” will also be determined with reference to the above explanations, and it will be possible to control the mixing conditions by using the combustible gas transport device so that the “flow velocity of the combustible gas at the combustion supporting gas supply port” is not less than the “combustion velocity of the mixed gas of the combustible gas and the combustion supporting gas.”

As a result, even if the combustion reaction occurs, since the combustible gas flows at a flow velocity which is not less than the combustion velocity, the combustible gas blows out the combustion reaction and therefore propagation of the combustion reaction can be effectively prevented. Since this effect of preventing the propagation of the combustion reaction is significant, it becomes possible to reduce a content ratio of an inert gas in the combustible gas and/or the combustion supporting gas, and therefore to improve a production efficiency of the mixed gas per volume (or space). Further, packing becomes unnecessary or its amount can be reduced, thus it becomes possible to improve a production efficiency of the mixed gas per volume and to reduce a pressure loss from a supply pressure of the combustible gas and/or the combustion supporting gas during the production of the mixed gas.

The mixer in this embodiment shows a smaller pressure loss than a conventional mixer which is filled with packing, and thus it is more effective, a cost for driving the combustible gas transport device tends to be reduced.

However, the controlling of the supply of the combustible gas into the tubular mixing section so that the flow velocity of the combustible gas at the combustion supporting gas supply port 5 is not less than the combustion velocity of the mixed gas of the combustible gas and the combustion supporting gas, is not necessary to the present embodiment.

The mixed gas prepared as described above can be used for any applications. Although the present embodiment is not limited, when an olefin(s) and hydrogen are used for the combustible gas and oxygen is used for the combustion supporting gas, the mixed gas resulted thereby can produce hydrogen peroxide from hydrogen and oxygen, and therefore the mixed gas can be used for an epoxidation reaction of an olefin(s). For example, when propylene is used as the olefin, it is possible to produce propylene oxide.

In the above, one embodiment of the present invention is described, but the present embodiment can be modified variously. For example, the juxta-tip part 4b of the combustion supporting gas supply tube 4 is shown in FIG. 1 as having the outer shape linearly graded towards the combustion supporting gas supply port 5 at the tip 4a. However, as long as the juxta-tip part 4b is tapered towards the tip 4a, it may have other outer shape such as a curved or generally streamlined shape.

### Embodiment 2

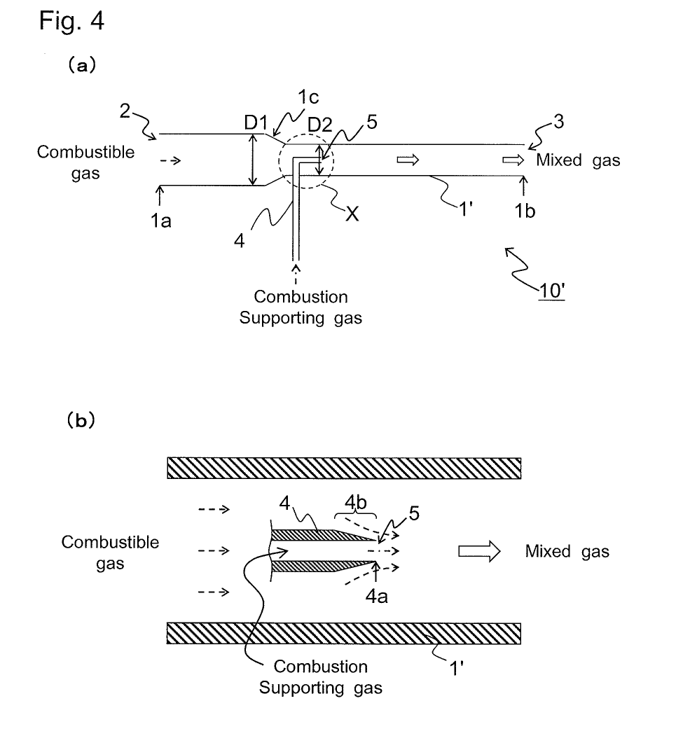

A mixer and a process for producing a mixed gas in another embodiment of the present invention will be described with reference to FIG. 4. This embodiment is a modification of Embodiment 1 described above, and similar explanations to Embodiment 1 are applicable to this embodiment unless otherwise stated.

As to a mixing apparatus 10′ in this embodiment, as shown in FIG. 4 (a), a tapered part 1c is formed between a position where the combustion supporting gas supply port 5 exists and a position in the vicinity of the one end 1a of a tubular mixing section 1′ so that a cross-sectional area of the tubular mixing section 1′ at the position of the combustion supporting gas supply port 5 is smaller than a cross-sectional area of the tubular mixing section 1′ at the position in the vicinity of the one end 1a of the tubular mixing section.

In a case where the tubular mixing section has a generally circular cross-section, an inner diameter D1 of the tubular mixing section 1′ at the position in the vicinity of the one end 1a of the tubular mixing section is larger than an inner diameter D2 of the tubular mixing section 1′ at the position of the combustion supporting gas supply port 5. As shown in FIG. 4 (a), a generally cylindrical part located at an upstream side (one end 1a side) of the tapered part 1c and a generally cylindrical part located at a downstream side (the other end 1b side) of the tapered part 1c can be substantially coaxially arranged, and the tapered part 1c has a shape of a circular truncated cone to form a continuous connection between these generally cylindrical parts.

The inner diameter D2 of the tubular mixing section 1′ at the position of the combustion supporting gas supply port 5 is shown in the drawings as being equal to an inner diameter of the generally cylindrical part located at the downstream side of the tapered part 1c, but the present embodiment is not limited thereto.

Also in this embodiment, as shown in FIG. 4 (b), the juxta-tip part 4b of the combustion supporting gas supply tube 4 has an outer shape tapered towards the combustion supporting gas supply port 5 at the tip 4a.

According to the present embodiment, the combustible gas is to flow through a smaller cross-sectional area at the position of the combustion supporting gas supply port 5, thereby the flow velocity of the combustible gas is further increased. To this extent, a load for the combustible gas transport device can be further reduced while the flow velocity of the combustible gas at the combustion supporting gas supply port 5 is effectively controlled to be not less than the combustion velocity of the mixed gas of the combustible gas and the combustion supporting gas. Alternatively, when the operation conditions of the combustible gas transport device are maintained, since the flow velocity of the combustible gas is increased, propagation of the combustion reaction can be prevented more securely.

This embodiment can also be modified similarly to Embodiment 1.

### INDUSTRIAL APPLICABILITY

According to the present invention, there is provided a safer mixer which can make mixing rapidly within a concentration range to prevent propagation of a combustion reaction although a combustible gas and a combustion supporting gas are mixed together.

The present application claims priority to Japanese Patent Application No. 2009-226846 filed on Sep. 30, 2009, and entitled “MIXER OF COMBUSTIBLE GAS AND COMBUSTION SUPPORTING GAS.” The contents of that application are incorporated herein by the reference thereto in their entirety.

1. A mixer for mixing a combustible gas and a combustion supporting gas, which comprises:
a tubular mixing section which extends between one end having a combustible gas supply port and the other end having a mixed gas discharge port; and
a combustion supporting gas supply tube which is inserted into the tubular mixing section between the one end and the other end of the tubular mixing section and has a combustion supporting gas supply port at its tip to open towards the other end of the tubular mixing section;
wherein a juxta-tip part of the combustion supporting gas supply tube has an outer shape tapered towards the combustion supporting gas supply port at the tip.

2. The mixer according to claim 1, wherein a longitudinal direction of the tubular mixing section is generally perpendicular to an aperture plane of the combustion supporting gas supply port.

3. The mixer according to claim 1, wherein a central axis of the combustion supporting gas supply tube at the juxta-tip part is generally parallel to a longitudinal direction of the tubular mixing section.

4. A process for producing a mixed gas, which comprises:
using the mixer according to claim 1;
supplying a combustible gas into the tubular mixing section from the combustible gas supply port located at the one end of the tubular mixing section;
supplying a combustion supporting gas into the tubular mixing section from the combustion supporting gas supply port;
mixing the combustible gas and the combustion supporting gas between the combustion supporting gas supply port and the other end of the tubular mixing section;
discharging a mixed gas obtained thereby from the mixed gas discharge port located at the other end of the tubular mixing section.

5. The process for producing the mixed gas according to claim 4, which further comprises:
controlling the supply of the combustible gas into the tubular mixing section so that a flow velocity of the combustible gas at the combustion supporting gas supply port is not less than a combustion velocity of the mixed gas of the combustible gas and the combustion supporting gas.

6. The process for producing the mixed gas according to claim 4, wherein the combustible gas comprises hydrogen, and the combustion supporting gas comprises oxygen.

7. The process for producing the mixed gas according to claim 6, wherein the combustible gas further comprises propylene.

8. The process for producing the mixed gas according to claim 6, wherein the combustible gas further comprises an inert component.
